(19) United States
(12) Patent Application Publication
(10) Pub. No.: US 2019/0114542 A1
(43) Pub. Date: Apr. 18, 2019

(54) ELECTRONIC APPARATUS AND CONTROL METHOD THEREOF

(71) Applicant: Samsung Electronics Co., Ltd., Gyeonggi-do (KR)

(72) Inventors: Kyoung-hoon Kim, Gyeonggi-do (KR); Young-hwan Park, Gyeonggi-do (KR); Dong-kwan Suh, Gyeonggi-do (KR); Keshava Prasad Nagaraja, Gyeonggi-do (KR); Dae-hyun Kim, Seoul (KR); Suk-jin Kim, Seoul (KR); Han-su Cho, Gyeonggi-do (KR); Hyun-jung Kim, Gyeonggi-do (KR)

(73) Assignee: Samsung Electronics Co., Ltd.

(21) Appl. No.: 16/031,565

(22) Filed: Jul. 10, 2018

Related U.S. Application Data
(60) Provisional application No. 62/571,599, filed on Oct. 12, 2017.

(30) Foreign Application Priority Data
Feb. 26, 2018 (KR) 10-2018-0022960

(51) Int. Cl. G06N 3/08; G06N 3/063

(52) U.S. Cl. CPC G06N 3/08; G06N 3/063

(57) ABSTRACT

An electronic apparatus and method thereof are provided for performing deep learning. The electronic apparatus includes a storage configured to store target data and kernel data; and a processor including a plurality of processing elements that are arranged in a matrix shape. The processor is configured to input, to each of the plurality of processing elements, a first non-zero element from among a plurality of first elements included in the target data, and sequentially input, to each of a plurality of first processing elements included in a first row from among the plurality of processing elements, a second non-zero element from among the plurality of elements included in the kernel data. Each of the plurality of first processing elements is configured to perform an operation between the input first non-zero element and the input second non-zero element, based on depth information of the first non-zero element and depth information of the second non-zero element.

### CROSS-REFERENCE TO RELATED APPLICATIONS

This application is based on and claims priority under 35 U.S.C. § 119 to Korean Patent Application No. 10-2018-0022960, filed on Feb. 26, 2018, in the Korean Intellectual Property Office, and U.S. Provisional Patent Application No. 62/571,599, filed on Oct. 12, 2017 in the U.S. Patent and Trademark Office, the disclosure of each of which is incorporated herein by reference in its entirety.

### BACKGROUND

### 1. Field

The present disclosure relates generally to an electronic apparatus and a controlling method thereof and, more particularly, to an electronic apparatus and a control method for performing a convolution operation.

### 2. Description of the Related Art

A touch sensing device, such as a touch pad, is capable of providing an input method using its own body without a separate input device such as a mouse or a keyboard. The touch sensing device is commonly applied to portable electronic devices for which a separate input device, such as a notebook, is difficult to be used.

In recent years, artificial intelligence systems that implement human-level intelligence have been used in various fields. In an artificial intelligence system, a machine learns, makes determinations, and becomes smarter, unlike an existing rule-based smart system. Artificial intelligence systems are becoming more and more common, and existing rule-based smart systems are being replaced by these types of deep-learning-based artificial intelligence systems.

Artificial intelligence technology includes machine learning (e.g., deep learning) and elementary technologies that utilize machine learning.

Machine learning includes an algorithm technology that classifies/learns characteristics of input data by itself. Elementary technology simulates functions, such as recognition and judgment of human brain, using machine learning algorithms, such as deep learning. The elementary technology includes technology fields, such as linguistic understanding, visual understanding, reasoning/prediction, knowledge representation, and motion control.

Artificial intelligence technology may by applied in linguistic understanding, visual understanding, reasoning/prediction, knowledge representation, and motion control.

Linguistic understanding is a technology for recognizing, applying/processing human language/characters and includes natural language processing, machine translation, dialogue system, query response, speech recognition/synthesis, etc. Visual understanding is a technology for recognizing and processing objects as human vision, including object recognition, object tracking, image search, human recognition, scene understanding, spatial understanding, image enhancement, etc. Reasoning/prediction is technology for determining information, logically reasoning, and predicting information, including knowledge/probability based reasoning, optimization prediction, preference-based planning, and recommendation.

Knowledge representation is a technology for automating human experience information into knowledge data, including knowledge building (data generation/classification) and knowledge management (data utilization). Motion control is a technology for controlling the self-driving of a vehicle and the motion of the robot, including motion control (navigation, collision, driving), and manipulation control (behavior control), etc.

In particular, a convolutional neural network (CNN) has a structure for learning two-dimensional data or three-dimensional data, and can be trained through a backpropagation algorithm. A CNN is widely used in various application fields, such as object classification, object detection, etc.

Most operations of a CNN are convolution operations, and most of the convolution operations include multiplication processing between input data. However, the target data (e.g., an image) and the kernel data that are input data may include a plurality of zeros, and as such, it is unnecessary to perform a multiplication operation in these cases.

For example, when at least one of the input data is zero in a multiplication operation between input data, the multiplication result is zero. That is, if at least one of the input data is zero, even if the multiplication operation is not performed, it can be known that the result is zero. Therefore, an operation cycle can be shortened by omitting unnecessary multiplication operations, which are expressed as processing data sparsity.

However, in the related art, the only method that has been developed for processing data sparsity when a plurality of processing elements are implemented is in the form of a one-dimensional array. Accordingly, a need exists for a method of processing data sparsity when a plurality of processing elements are implemented in the form of a two-dimensional array.

### SUMMARY

The present disclosure has been made to address the above-mentioned problems and disadvantages, and to provide at least the advantages described below.

Accordingly, an aspect of the present disclosure is to provide an electronic apparatus that omits an unnecessary operation in a convolution operation process to improve an operation speed and a control method thereof.

Another aspect of the present disclosure is to provide an electronic apparatus that may improve speed of a convolution operation by omitting an operation of part of target data and part of kernel data according to zero included in the target data and a control method thereof.

In accordance with an aspect of the present disclosure, an electronic apparatus is provided for performing deep learning. The electronic apparatus includes a storage configured to store target data and kernel data; and a processor configured to include a plurality of processing elements that are arranged in a matrix shape, and the processor is configured to input, to each of the plurality of processing elements, a first non-zero element from among a plurality of first elements included in the target data, and sequentially input, to each of a plurality of first processing elements included in a first row from among the plurality of processing elements, a second non-zero element from among the plurality of elements included in the kernel data, wherein each of the plurality of first processing elements is configured to perform operation between the input first non-zero element and the input second non-zero element based on depth information of the first non-zero element and depth information of the second non-zero element.

In accordance with another aspect of the present disclosure, a method is provided for controlling an electronic apparatus to perform deep learning. The method includes inputting, to each of the plurality of processing elements, a first non-zero element from among a plurality of first elements included in the target data; sequentially inputting, to each of a plurality of first processing elements included in a first row from among the plurality of processing elements, a second non-zero element from among the plurality of elements included in the kernel data; and performing operation between the input first non-zero element and the input second non-zero element based on depth information of the first non-zero element and depth information of the second non-zero element.

### BRIEF DESCRIPTION OF THE DRAWINGS

The above and/or other aspects, features, and advantages of certain embodiments of the present disclosure will be more apparent from the following detailed description taken in conjunction with the accompanying drawings, in which:

FIGS. 1A and 1B illustrate a convolution operation between three-dimensional input data according to an embodiment;

FIG. 2 illustrates an electronic apparatus according to an embodiment;

FIG. 3 illustrates a plurality of processing elements according to an embodiment;

FIGS. 4A to 4D illustrate a method for inputting a non-zero element from among target data and kernel data according to an embodiment;

FIGS. 5A to 5M illustrate operation cycles of a processing element according to an embodiment;

FIGS. 6A and 6B illustrate a method for processing data sparsity of kernel data according to an embodiment;

FIGS. 7A and 7B illustrate a method for processing data sparsity of target data according to an embodiment;

FIG. 8 illustrates a processing element according to an embodiment; and

FIG. 9 is a flowchart illustrating a method of controlling an electronic apparatus according to an embodiment.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure.

In describing the drawings, similar reference numerals may be used to designate similar constituent elements. A detailed description of known functions or configurations will be omitted for the sake of clarity and conciseness.

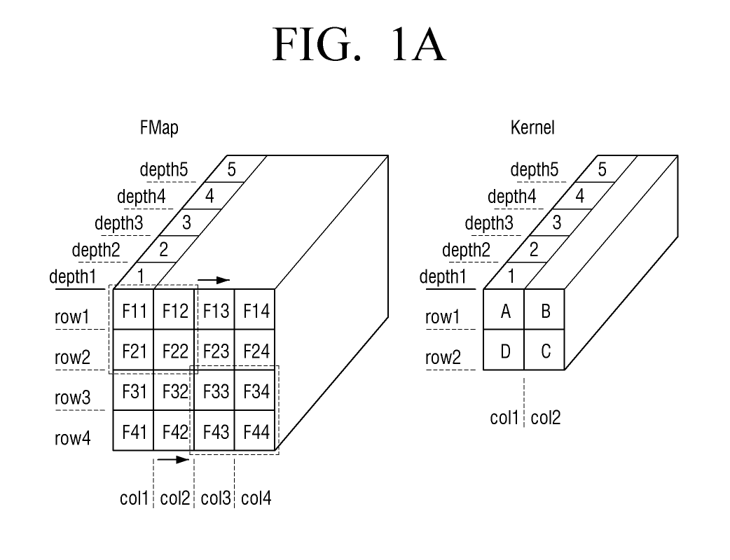

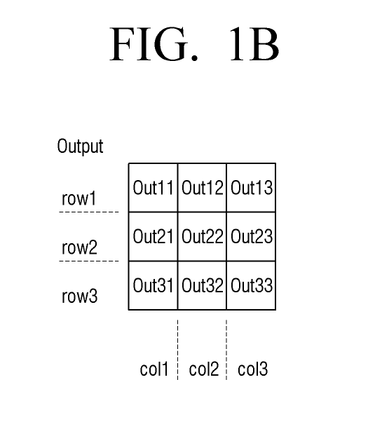

FIGS. 1A and 1B illustrate a convolution operation between three-dimensional input data according to an embodiment. A convolution operation is an operation performed with a very high weight in deep learning, which highlights characteristics corresponding to kernel data from target data through operation of the target data and the kernel data.

Referring to FIG. 1A, the left side of FIG. 1A illustrates an example of three-dimensional target data (Feature Map Data), and the right side of FIG. 1A illustrates an example of three-dimensional kernel data. For example, the target data is three-dimensional data including four rows, four columns, and a depth of five, and the kernel data is three-dimensional data including two rows, two columns, and a depth of five.

Referring to FIG. 1B, which illustrates output data according to the convolution operation of the target data and kernel data of FIG. 1A, the output data is two-dimensional data including three rows and three columns.

From among the output data, Out11 can be calculated using Equation (1).

Out11=F11,1×A,1+F11,2×A,2+F11,3×A,3+F11,4×A,4+F11,5×A,5+F12,1×B,1+F12,2×B,2+F12,3×B,3+F12,4×B,4+F12,5×B,5+F21,1×D,1+F21,2×D,2+F21,3×D,3+F21,4×D,4+F21,5×D,5+F22,1×C,1+F22,2×C,2+F22,3×C,3+F22,4×C,4+F22,5×C,5 (1)

In Equation (1), the left side of the comma of F11,1 indicates the row and column of the target data, and the right side of F11,1 indicates the depth of the target data. For example, F21,3 indicates the second row, the first column and the third depth of the target data, and the remaining target data are also displayed in the same manner. The left comma of A,1 indicates the row and column of the kernel data, and the right side of the comma indicates the depth of the kernel data. For example, D,4 represents the second row, the first column and the fourth depth of the kernel data, and the remaining kernel data are displayed in the same manner. Hereinafter, the above-described notation is used for easier description.

The remainder of the output data can be calculated by operating the same kernel data and other rows and columns of the target data. For example, Out23 out of the output data can be calculated by operating the data included in all of the depths of F23, F24, F33, and F34 and the kernel data from the target data.

As described above, in order to perform the convolution operation between the three-dimensional input data, the depth of the three-dimensional input data needs to be the same. Further, even if the input data is three-dimensional data, the output data can be changed into two-dimensional data.

In addition, FIG. 1B illustrates a result of omitting an operation with respect to the outline pixels of the target data, and another type of output data may be generated as the operation on the outline pixel is added.

In the following description, for convenience of description, individual data, which constitutes target data, such as F11,1, F11,2, F11,3, F11,4, F11,5, F21,1 . . . , F44,4, and F44,5, is described as a first element; individual data, which constitutes kernel data, such as A,1, A,2, A,3, A,4, B,1, . . . , C,4, D,1, D,2, D,3, and D,4, is described as a second element. In addition, the reference directions of the rows, columns, and depths illustrated in FIGS. 1A and 1B are the same in the following drawings.

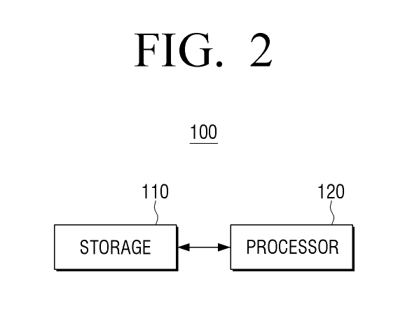

FIG. 2 illustrates an electronic apparatus according to an embodiment.

Referring to FIG. 2, the electronic apparatus 100 includes a storage 110 and a processor 120.

The electronic apparatus 100 may perform deep learning, i.e., a convolution operation. For example, the electronic apparatus 100 may be a desktop personal computer (PC), a notebook, a smart phone, a tablet PC, a server, etc. Alternatively, the electronic apparatus 100 may be a system itself, in which a cloud computing environment is built. However, the present disclosure is not limited thereto, and the electronic apparatus 100 may be any device capable of performing a convolution operation.

The storage 110 may store target data, kernel data, etc. The target data and the kernel data may be stored so as to correspond to a type of the storage 110. For example, the storage 110 may include a plurality of two-dimensional cells, and three-dimensional target data and kernel data may be stored in a plurality of two-dimensional cells.

The processor 120 may identify data stored in a plurality of two-dimensional cells as three-dimensional target data and kernel data. For example, the processor 120 may identify the data stored in cells 1 to 25, among the plurality of cells, as data of a first depth of the target data, and the data stored in cells 26 to 50, among the plurality of cells, as data of a second depth of the target data.

The kernel data may be generated by the electronic apparatus 100, or may generated and received by an external electronic apparatus, i.e., not the electronic apparatus 100. The target data may be information received from an external electronic apparatus.

The storage 110 may be implemented as a hard disk, a non-volatile memory, a volatile memory, etc.

The processor 120 generally controls the operation of electronic apparatus 100.

The processor 120 may be implemented as a digital signal processor (DSP), a microprocessor, or a time controller (TCON), but is not limited thereto, and may include at least one of a central processing unit (CPU), a microcontroller unit (MCU), a micro processing unit (MPU), a controller, an application processor (AP), a communication processor (CP), and an ARM processor. The processor 120 may be implemented as a system on chip (SoC), a large scale integration (LSI) with a processing algorithm embedded therein, or in a format of a field programmable gate array (FPGA).

The processor 120 may include a plurality of processing elements arranged in a matrix form, and may control the operation of a plurality of processing elements.

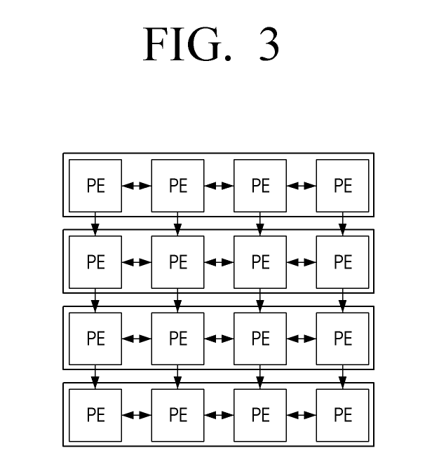

FIG. 3 illustrates a plurality of processing elements according to an embodiment.

Referring to FIG. 3, a plurality of processing elements (PEs) are arranged in a matrix form, and data can be shared between adjacent processing elements. Although FIG. 3 illustrates the data being transmitted from an upper side to a lower side, the present disclosure is not limited thereto, and data may be transmitted from the lower side to the upper side.

Each of the plurality of processing elements includes a multiplier and an arithmetic logic unit (ALU). The ALU may include at least one adder. Each of the plurality of processing elements can perform arithmetic operations using a multiplier and an ALU. Further, each of the plurality of processing elements may include a plurality of register files.

The processor 120 may input a first non-zero element among the plurality of first elements included in the target data to each of the plurality of processing elements. For example, the processor 120 may identify a first non-zero element, i.e., an element that is not zero, from the target data stored in the storage 100, and input the identified first non-zero element into the plurality of processing elements. That is, the processor 120 may extract only the first non-zero element from the target data stored in the storage 110 in real time.

Alternatively, the processor 120 may extract only the first non-zero element from the target data, prior to inputting the first non-zero element to the plurality of processing elements, and store the first non-zero element in the storage 110. The storage 110 may store the target data and the extracted first non-zero element. The processor 120 may directly input the extracted first non-zero element into the plurality of processing elements. The processor 120 may identify the corresponding processing element among the plurality of processing elements based on the row information and the column information of the first non-zero element, and input the first non-zero element to the identified processing element.

For example, the processor 120 may be configured to input the first non-zero element to a first processing element from among a plurality of processing elements, if the first non-zero element is a first row and a first column, and if the first non-zero element is the second row and the second column, the first non-zero element may be input to the second processing element from among a plurality of processing elements. The first non-zero element, which belongs to the first row and the first column, may include a plurality of elements with different depths, and the processor 120 may input a plurality of first non-zero elements belonging to the first row and the first column to each of a plurality of register files of the first processing element.

The processor 120 may input the first non-zero element into the corresponding register file from among the plurality of register files included in the processing element identified based on the depth information of the first non-zero element. The processing element may include a plurality of register files corresponding to each of the depths of the target data.

For example, the processing element may include a first register file corresponding to the first depth of the target data, a second register file corresponding to the second depth, . . . , and an n-th register file corresponding to the n-th depth, and the processor 120 may input an element of the first depth from among the first non-zero elements belonging to the first row and the first column to the first register file included in the first processing element, and input the element of the second depth to the second register file included in the first processing element. If there is no element of the second depth from among the first non-zero elements belonging to the first row and the first column, the second register file included in the first processing element may not store the element. However, the present disclosure is not limited thereto, and the processor 120 may sequentially input the first non-zero element into a plurality of register files included in the identified processing element, without considering the depth information of the first non-zero element. For example, the processor 120 may store the depth information of the first non-zero element stored in each register file along with the first non-zero element.

If the first non-zero element that belongs to the first row and the first column is a first depth, a third depth, or a fourth depth element, the processor 120 may input the first non-zero element to the first register, file, the second register file, and the third register file sequentially. The processor 120 may store that the first non-zero element stored in the first register file as an element of the first depth, the first non-zero element stored in the second register file as an element of the third depth, and the first non-zero element stored in the third register file as an element of the fourth depth.

The processor 120 may sequentially input the second non-zero element from among a plurality of second elements included in the kernel data to each of the plurality of first processing elements included in the first row among the plurality of processing elements.

The processor 120 may identify the second non-zero element from the kernel data stored in the storage 110 and sequentially input the identified second non-zero element to each of the plurality of first processing elements. That is, the processor 120 may extract only the second non-zero element in real time from the kernel data stored in the storage 110.

Herein, an operation to sequentially input refers to the input order of the elements in the plurality of second non-zero elements. For example, if there are second non-zero element of the first depth, the second non-zero element of the second depth, and the second non-zero element of the third depth, the processor 120 may input the second non-zero element of the first depth to each of the plurality of first processing elements in the first cycle, input the second non-zero element of the second depth to each of the plurality of first processing elements in the second cycle, and input the second non-zero element of the third depth to each of the plurality of first processing elements in the third cycle.

Alternatively, the processor 120 may extract only the second non-zero element from the kernel data, before inputting the second non-zero element to each of the plurality of first processing elements, and store the extracted second non-zero element in the storage 110. In this case, the storage 110 may store the kernel data and the extracted second non-zero element. The processor 120 may sequentially input the extracted second non-zero element into each of the plurality of first processing elements.

The plurality of first processing elements included in the first row among the plurality of processing elements may be a plurality of processing elements arranged at one corner of the plurality of processing element matrices. For example, the plurality of first processing elements may be four processing elements arranged at the top portion of FIG. 3.

The processor 120 may sequentially input the second non-zero element to each of the plurality of first processing elements based on the row information, the column information, and the depth information of the second non-zero element. The processor 120 may sequentially input the second non-zero element along with the depth information of the second non-zero element to the plurality of first processing elements.

The processor 120 sequentially inputs the second non-zero element included in one row and one column of the second non-zero elements to each of the plurality of first processing elements based on the depth. When all of the second non-zero elements included in one row and one column are input to each of the plurality of first processing elements, the second non-zero element included in a row and a column, which are different from one row and column, to each of the plurality of first processing elements.

For example, the processor 120 may sequentially input the second non-zero element included in a first row and a second column to each of the plurality of first processing elements, and when input of the second non-zero element included in the first row and the first column is completed, the processor may sequentially input the second non-zero element included in the first row and the second column to each of the plurality of first processing elements in an order of depth.

The processor 120 may input one second non-zero element into each of the plurality of first processing elements, and when the cycle is changed, may input the second non-zero element in a next order to each of the plurality of first processing elements.

In addition, the processor 120 inputs a zero into each of the plurality of first processing elements when there is no second non-zero element in one row and one column, and when zero is input to each of the plurality of first processing elements, may input the second non-zero element or zero included in a different row or column to each of a plurality of the first processing elements based on the number of second non-zero elements included in a different row and column.

When the operation between the elements corresponding to one row and one column is completed, the accumulation result are shifted, which is the reason for inputting a zero.

The processor 120, when a depth which has no first non-zero element in all of the rows and columns is identified from among first non-zero elements stored in each of the plurality of processing elements, may omit input of a second non-zero element that corresponds to the depth and sequentially input the second non-zero element that does not correspond to the depth to each of the plurality of first processing elements.

For example, if there is no first non-zero element corresponding to the third depth from among the first non-zero elements stored in each of the plurality of processing elements, the processor 120 may omit input of the second non-zero element corresponding to the third depth from among the second elements. More specifically, if the second non-zero element belong to the first row and the first column is an element of the first depth, the third depth, or the fourth depth, the processor 120 may input the element of the first depth from among the second non-zero elements belonging to the first row and the first column to each of the plurality of processing elements, and if a cycle is changed, the processor 120 may input the element of the fourth depth to each of the plurality of first processing elements from among the second non-zero element belonging to the first row and the first column. That is, even if the elements of the third depth among the second non-zero elements belonging to the first row and the first column are input to each of the plurality of first processing elements, unless there is no first non-zero element which corresponds to the third depth, the operation result is zero, and the processor 120 may shorten the cycle by not inputting the element of the third depth from among the second non-zero elements belonging to the first row and the first column.

Alternatively, the processor 120 may further include a plurality of preliminary processing elements. When a depth has a non-zero element that is within a predetermined number in all of the rows and columns, from among the first non-zero elements stored in each of the plurality of processing elements, the processor 120 may omit input of the second non-zero element corresponding to the depth and sequentially input the second non-zero elements not corresponding to the depth to each of the plurality of first processing elements, and input the first non-zero element corresponding to the depth and the second non-zero element corresponding to the depth to a plurality of preliminary processing elements to perform the operation.

For example, from among the first non-zero element stored in each of the plurality of processing elements, if the first non-zero element corresponding to the third depth is less than five, the processor 120 may omit input of the second non-zero element corresponding to the third depth and sequentially input the second non-zero elements not corresponding to the third depth to each of the plurality of first processing elements, and input the first non-zero element corresponding to the third depth and the second non-zero element corresponding to the third depth to a plurality of preliminary processing elements to perform the operation.

Each of the plurality of first processing elements may perform an operation on the input first non-zero element and the input second subject, based on the depth information of the first non-zero element and the depth information of the second non-zero element.

The remaining processing elements from among the plurality of processing elements may receive the second non-zero elements from the adjacent processing elements. Each of the remaining processing elements may perform an operation between the input first non-zero element and the input second non-zero element based on the depth information of the first non-zero element and the depth information of the second non-zero element.

The first non-zero element and the second non-zero element can be input to each of the plurality of processing elements on a cycle-by-cycle basis. In this case, each of the plurality of processing elements can perform operation between the first non-zero elements and the second non-zero elements that are input by cycles based on the respective depth information.

Alternatively, the first non-zero element may be preliminarily input to the plurality of processing elements at a time, and the second non-zero element may be input to each of the plurality of processing elements for each cycle. In this case, each of the plurality of processing elements may perform an operation between a prestored first non-zero element and a second non-zero element, which is input by cycles, based on the respective depth information.

When the operation between the non-zero elements in the plurality of first processing elements is completed, the processor 120 may control the plurality of processing elements to shift the second non-zero elements that are input to the plurality of first processing elements to each of the plurality of second processing elements included in the second row. When the operation between the non-zero elements is completed in the plurality of second processing elements, the processor 120 may control the plurality of processing elements to shift the second non-zero elements which are shift to the plurality of second processing elements to each of the plurality of third processing elements included in the third row from among the plurality of processing elements.

When the second non-zero element that is input to each of the plurality of processing elements is included in the same row and the same column as the second non-zero element that is used in the operation that is performed immediately before, the processor 120 may accumulate the operation result by the input second non-zero element to the previous operation result and store the accumulated operation result in one of the plurality of register files. Here, the plurality of register files may include a register file for accumulating and storing a plurality of register files in which the first non-zero element is stored and the operation result.

When the second non-zero element that is input to each of the plurality of processing elements is not included in the same row and the same column as the second non-zero element that is used in the operation that is performed immediately before, the processor 120 may shift the operation result that is stored in one of the plurality of register files of the plurality of processing elements to an adjacent processing element, and store the operation result by the input second non-zero element to one of the plurality of register files by accumulating the operation result to the shifted operation result.

Through the above-described method, the processor 120 may shorten unnecessary operations between the target data and the kernel data.

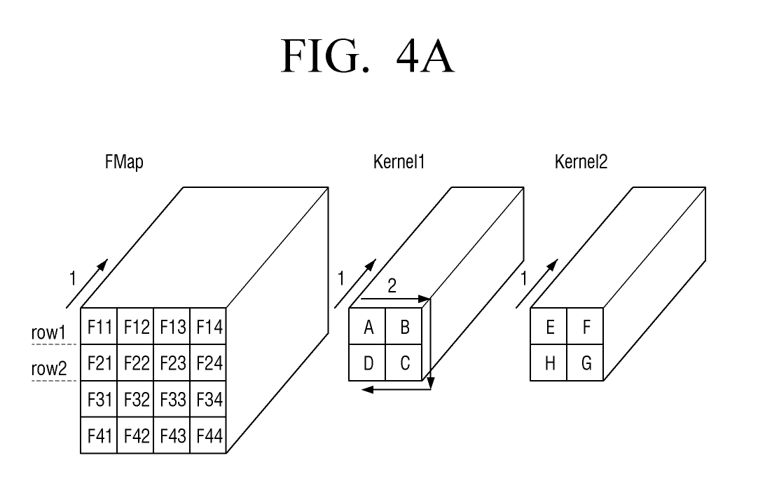

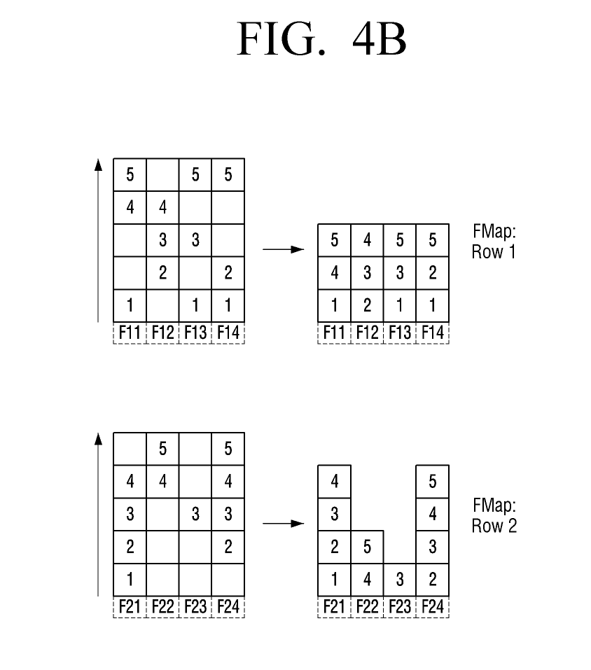

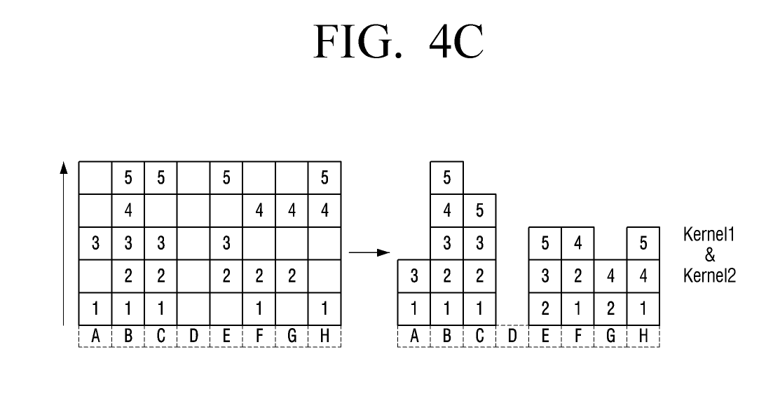

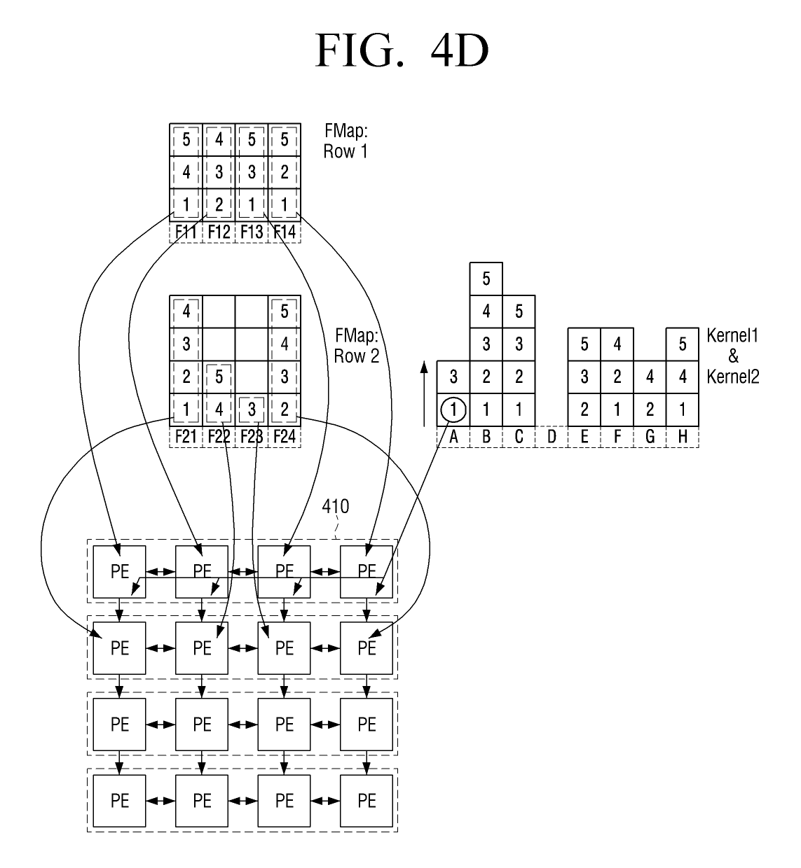

FIGS. 4A to 4D illustrate a method for inputting a non-zero element from among target data and kernel data according to an embodiment.

Referring to FIG. 4A, the left side of FIG. 4A illustrates three-dimensional target data, and the right side of FIG. 4A illustrates three-dimensional first kernel data and the three-dimensional second kernel data.

Because the kernel data is sequentially input to the plurality of first processing elements, it is possible to easily operate a plurality of kernel data.

In FIG. 4A, the first arrow direction toward the right upper end indicates the depth direction, and the second arrow direction rotating in a clockwise direction indicates the order of operation of the kernel data. When the operation of kernel data of the depths corresponding to A is completed, an operation of kernel data of the depths corresponding to B can then be performed. That is, the order of operations, for the entire depth thereof, may be A->B->C->D.

Referring to FIG. 4B, the left upper end of FIG. 4B illustrates the first row in the target data, and the lower left end of FIG. 4B illustrates the second row in the target data. The arrow direction represents the depth direction as shown by the first arrow direction in FIG. 4A.

The number shown on the left side of FIG. 4B represents the index of the depth, and the element is not zero, and the depth without the number represents when the element is zero. For example, in the first row and the first column of the target data, the elements of the first depth, the fourth depth, and the fifth depth are not zero, and the elements of the second depth and the third depth are zero.

The right side of FIG. 4B illustrates only the first non-zero element from the left side of FIG. 4B. The processor 120 may identify the first non-zero element from the target data as shown in the left side of FIG. 4B, and input the identified first non-zero element into the plurality of processing elements. Alternatively, the processor 120 may extract only the first non-zero element as shown in the right side of FIG. 4B, separately store the extracted first non-zero elements in the storage 110, and extract the stored first non-zero elements to input the elements to the plurality of processing elements. In this case, the processor 120 may first extract the first non-zero element in a depth direction of F11 of the first row, and then move to the side to extract the first non-zero element in the depth direction of F12 as illustrated in FIG. 4B. The processor 120 may extract the first non-zero element in the depth direction of each of F13 and F14 in the same manner. The processor 120 may extract the first non-zero element for the second row in the same manner.

In FIG. 4B, only the first row and the second row are shown in the target data for convenience of description, and only the first row and the second row of the target data will be described below for convenience of description. However, the operation for the remaining rows is the same as for the first row and the second row.

Referring to FIG. 4C, the left side of FIG. 4C illustrates first kernel data and second kernel data in accordance with a row and a column. The direction of the arrow in FIG. 4C indicates the depth direction as shown by the first arrow direction in FIG. 4A. The numbers illustrated on the left side of FIG. 4C represent the index of the depth and that the element is not zero, and a depth without a number represents that the element is a zero. For example, in the first row and the first column of the kernel data, the elements of the first and third depths are not zero, and the elements of the second depth, fourth depth, and fifth depth are zero.

The right side of FIG. 4C illustrates only the second non-zero element from the left side of FIG. 4C. The processor 120 may identify the second non-zero element from the kernel data as illustrated in the left side of FIG. 4C, and sequentially input the identified second non-zero element into the plurality of first processing elements. Alternatively, the processor 120 may extract only the second non-zero element as shown in the right side of FIG. 4C, separately store the identified second non-zero element in the storage 110, extract the stored second non-zero element to sequentially input to the plurality of the first processing element. In this case, the processor 120 may first extract the first non-zero element in a depth direction as illustrated in FIG. 4C, and then move to the side to extract the second non-zero element in the depth direction of B as shown in FIG. 4C. The processor 120 may extract the second non-zero element in the depth direction of each of C and D in the same manner.

The processor 120 may include a plurality of processing elements in the form of 4×4 matrix, e.g., as illustrated in FIG. 4D. The four processing elements included in the first row 410 at the upper end of the plurality of processing elements are referred to as a plurality of the first processing elements.

The processor 120 may input the first non-zero element included in the first row of the target data to the plurality of the first processing elements. For example, the processor 120 may input the elements of the first depth, the fourth depth, and the fifth depth included in the first row and the first column of the target data to a processing element located in the first from the left side from among the plurality of first processing elements, input the elements of the first depth, the third depth, and the fourth depth included in the first row and the second column of the target data to a processing element located in the second from the left side from among the plurality of first processing elements, input the elements of the first depth, the third depth, and the fifth depth included in the first row and the third column of the target data to a processing element located in the third from the left side from among the plurality of first processing elements, and input the elements of the first depth, the second depth, and the fifth depth included in the first row and the fourth column of the target data to a processing element located in the fourth from the left side from among the plurality of first processing elements.

The processor 120 may input the first non-zero element included in the second row of the target data to four processing elements (hereinafter, referred to as the plurality of second processing elements) included in a row that is positioned below the first row 410. For example, the processor 120 may input the elements of the first depth, the second depth, the third depth, and the fourth depth included in the second row and the first column of the target data to a processing element located in the first from the left side from among the plurality of second processing elements, input the elements of the fourth depth and the fifth depth included in the second row and the second column of the target data to a processing element located in the second from the left side from among the plurality of the second processing elements, input the elements of the third depth included in the second row and the third column of the target data to a processing element located in the third from the left side from among the plurality of the second processing elements, and input the elements of the second depth, the third depth, the forth depth, and the fifth depth included in the second row and the fourth column of the target data to a processing element located in the fourth from the left side from among the plurality of the second processing elements.

The processor 120 may sequentially input the second non-zero element included in the first row and the first column of the first kernel data to a plurality of the first processing elements in an order of depth.

The processor 120 may sequentially input the second non-zero element included in the first row and the first column of the first kernel data to the plurality of first processing elements, sequentially input the second non-zero element included in the first row and the second column of the first kernel data to the plurality of first processing elements, sequentially input the second non-zero elements included in the second row and the second column of the first kernel data to the plurality of the first processing elements, and sequentially input the second non-zero elements included in the second row and the first column of the first kernel data to a plurality of the first processing elements.

The processor 120 may sequentially input the second non-zero element included in the first kernel data to the plurality of first processing elements, and sequentially input the second non-zero elements included in the second kernel data to the plurality of the first processing elements.

For example, the processor 120 may sequentially input the elements of the first depth and the third depth included in the first row and the first column of the first kernel data to the plurality of first processing elements, sequentially input the elements of the first depth, second depth, third depth, fourth depth, and fifth depth included in the first row and the second column of the first kernel data to a plurality of the first processing elements, and sequentially input the elements of the first depth, second depth, third depth, and fifth depth included in the second row and the second column to the plurality of first processing elements. The processor 120 may input zero to the plurality of the first processing elements if the second non-zero element is not included in the second row and the first column of the first kernel data. In addition, the processor 120 may sequentially input the second non-zero element of the second kernel data to the plurality of the first processing elements, and the input order may be the same as the first kernel data.

The processor 120 may input one second non-zero element into the plurality of first processing elements, and sequentially input another second non-zero element to the plurality of first processing elements when the cycle is changed.

Each of the plurality of first processing elements can shift the input second non-zero element to an adjacent second processing element from among a plurality of the second processing elements when the cycle is changed. Each of the plurality of the second processing elements can shift the input second non-zero element to an adjacent processing element in a lower direction.

The processor 120 may input all of the first non-zero elements into the plurality of processing elements in the first cycle, and input the second non-zero element, which is the first, to the plurality of first processing elements. Thereafter, the processor 120 may input the second non-zero element, which is the second, to the plurality of first processing elements in the second cycle which follows the first cycle. That is, the processor 120 may only input the second non-zero element to the plurality of first processing elements in a following cycle.

Alternatively, the processor 120 may input all of the first non-zero elements in the first cycle and the first non-zero elements corresponding to the plurality of first processing elements into a plurality of first processing elements, and input the second non-zero element, which is the first, to the plurality of first processing elements. Thereafter, the processor 120 may input the first non-zero element, which corresponds to the plurality of second processing elements, to the plurality of second processing elements in the second cycle, and input the second non-zero element, which is the second, to the plurality of second processing elements. That is, the processor 120 may input a part of the first non-zero element to a plurality of the first processing element by cycles.

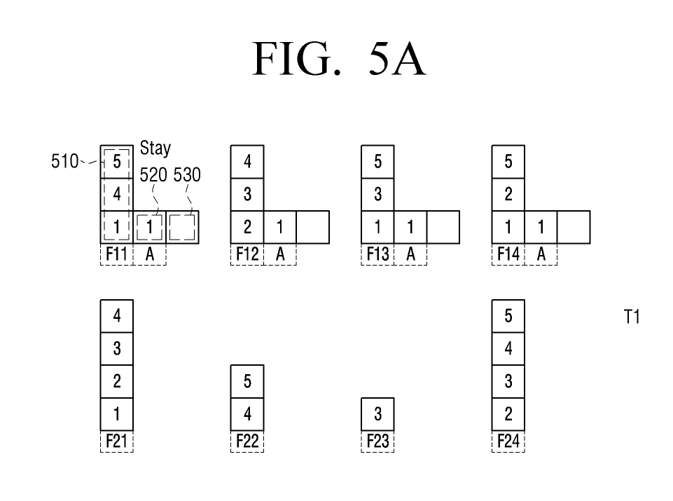

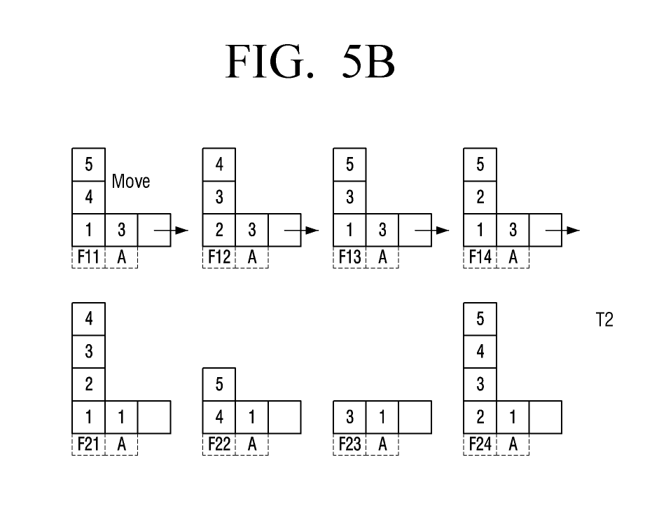

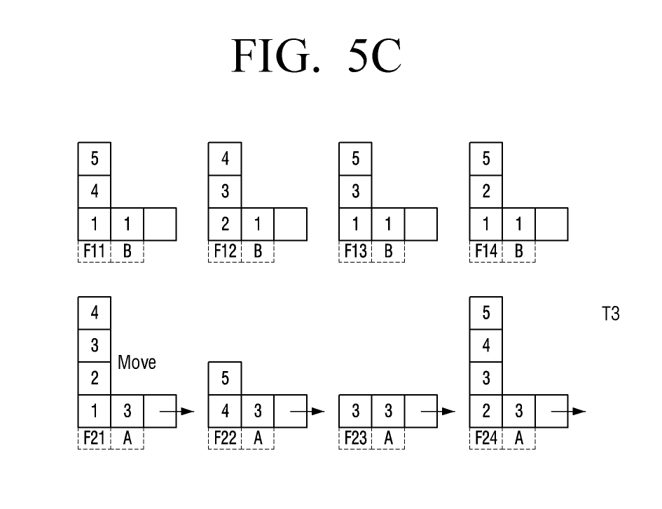

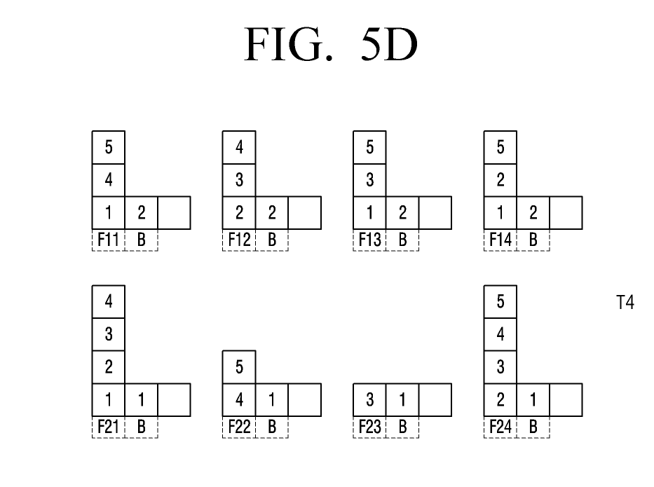

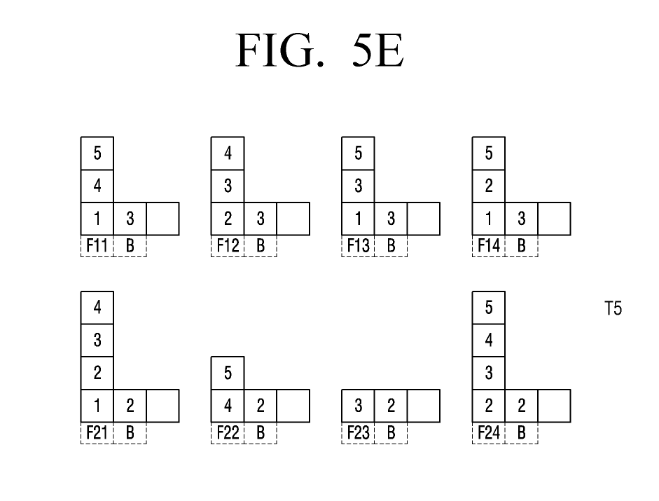

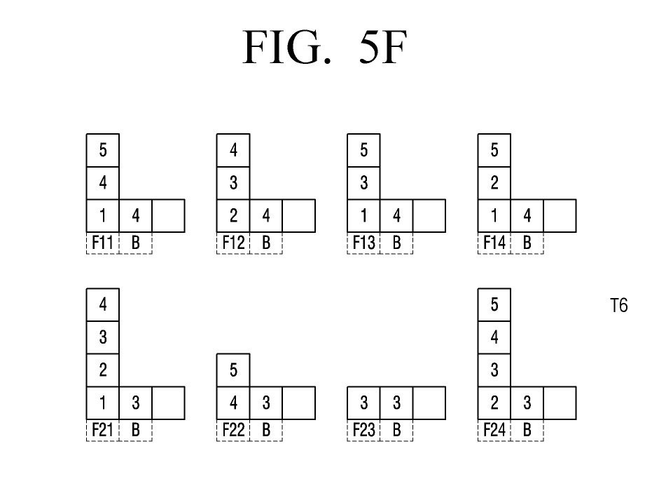

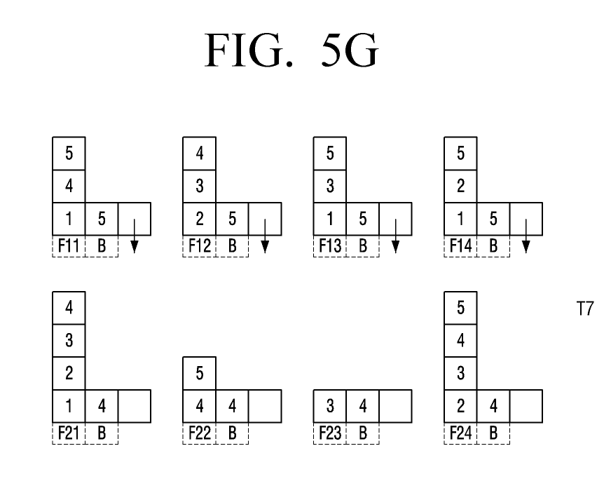

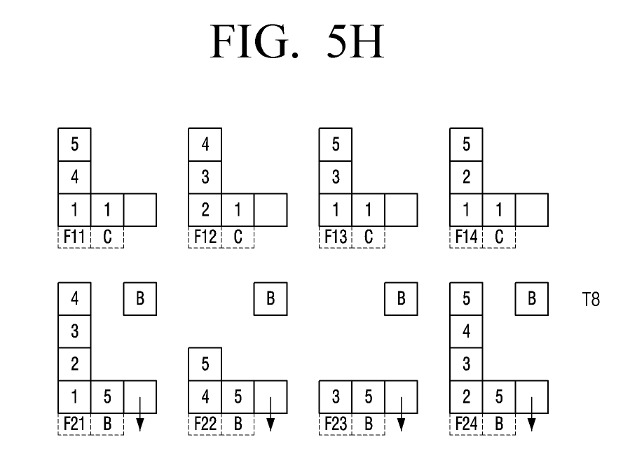

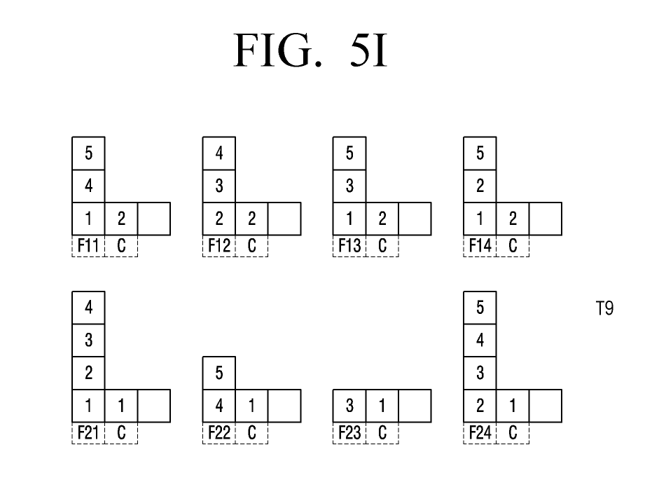

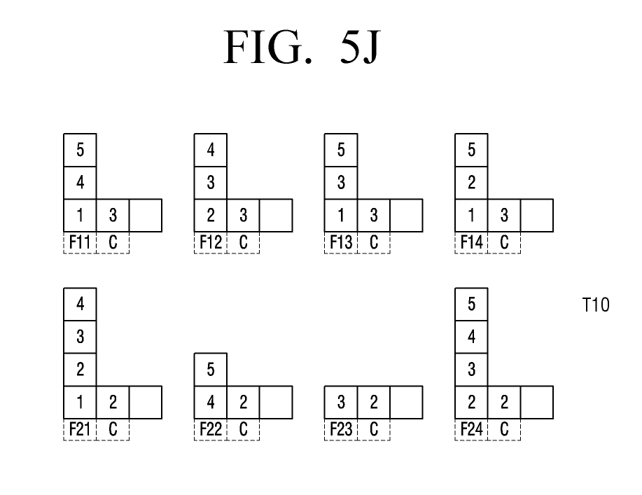

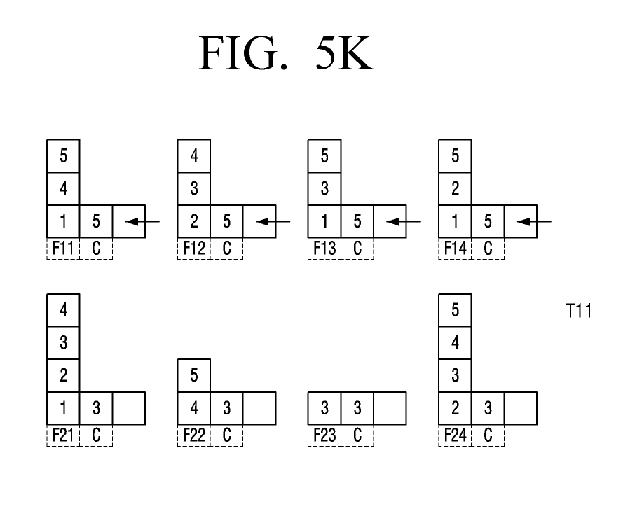

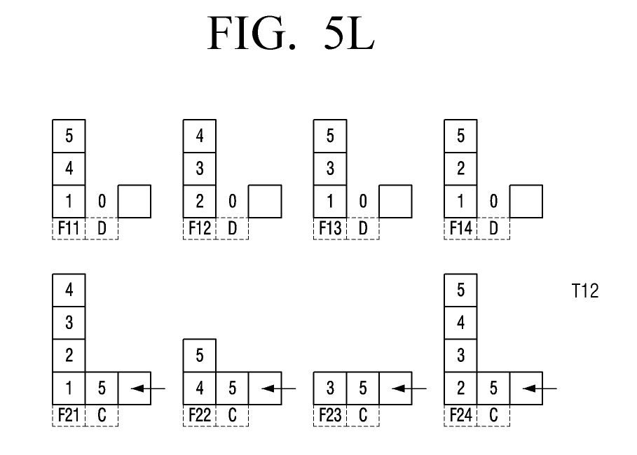

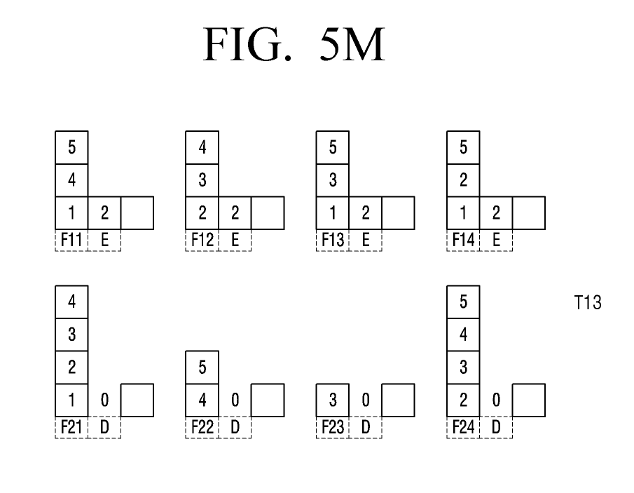

FIGS. 5A to 5M illustrate an operation of a processing an element by cycles according to an embodiment. For convenience of description, FIGS. 5A to 5M will be described with reference to the plurality of first processing elements and the plurality of second processing elements in FIGS. 4A to 4D. Specifically, FIGS. 5A to 5M illustrate a plurality of first processing elements on an upper side and a plurality of second processing elements on a lower side. Further, in each processing element, the left side represents the first non-zero element, the middle side indicates the second non-zero element, and the right side indicates the processing result.

Referring to FIG. 5A, the left upper side of FIG. 5A illustrates one of the plurality of first processing elements, and the left side 510 represents the first non-zero elements of the first depth, the fourth depth, and the fifth depth included in the first row and the first column in the target data, and the middle element 520 indicates the second non-zero element of the first depth included in the first row and the first column in the first kernel data, and the right side 530 indicates the operation result. However, the description of the concrete operation result value is omitted in the right side 530.

As illustrated in FIG. 5A, the processor 120 may input the first non-zero element into a first plurality of processing elements and a plurality of second processing elements in a first cycle. However, the present disclosure is not limited thereto, and the processor 120 may input the first non-zero element to the plurality of first processing elements in the first cycle and input the first non-zero element to the plurality of second processing elements in the second cycle. The processor 120 may input the first non-zero element corresponding to each processing element and further description will be omitted.

The processor 120 may input the second non-zero element to the first processing element in the first cycle. Here, the input second non-zero element is the second non-zero element of the first depth included in the first row and the first column of the first kernel data.

Each of the plurality of the first processing elements, based on the input first non-zero element depth information and the input second non-zero element depth information, may perform an operation between the input first non-zero element and the input second non-zero element and store the operation result. For example, the input second non-zero element is the element of the first depth, and thus, the first, third, and fourth processing elements from the left side where the first non-zero element of the first depth is stored can perform an operation between the first non-zero element and the second non-zero element. From among the plurality of the first processing elements, the second processing element from the left side in which the first non-zero element of the first depth is not stored does not perform operation between the first non-zero element and the second non-zero element. The operation result is stored in each processing element and is not shifted to an adjacent processing element.

The plurality of second processing elements do not perform the operation because the second non-zero element is not input.

Referring to FIG. 5B, the processor 120 can input the second non-zero element to the plurality of first processing elements. Here, the input second non-zero element is the second non-zero element of the third depth included in the first row and the first column of the first kernel data.

Each of the plurality of first processing elements can shift the second non-zero element to the adjacent second processing element in the first cycle.

Each of the plurality of first processing elements may perform inter-element operation between the input first non-zero element and the input second non-zero element. Each of the plurality of the first processing elements can shift the operation result to an adjacent processing element by adding the operation result of the second cycle with the operation result of the first cycle. The reason for shifting is that all of the second non-zero elements included in the first row and the first column are input in the first kernel data. That is, the second non-zero element input in the second cycle is the last second non-zero element included in the first row and the first column of the first kernel data.

The shift direction is determined according to the row and column where the element is located in the first kernel data in the next cycle. In the third cycle, the second non-zero element of the first depth included in the first row and the second column of the first kernel data will be input, and it is to the right side from the first row and the first column of the first kernel data. That is, the shift direction may be to the right side. If, in the third cycle, the second non-zero elements of the first depth included in the second row and the first column are to be input, this is a lower side from the first row and the first column of the first kernel data, and the shift direction may be to a lower side.

Each of the plurality of second processing elements can perform an inter-element operation between the first non-zero element and the second non-zero element inputted by the same operation method as the operation of the plurality of first processing elements in the previous cycle.

As illustrated in FIG. 5C, the processor 120 may input the second non-zero element to the plurality of first processing elements in the third cycle. Here, the input second non-zero element is the second non-zero element of the first depth included in the first row and the second column of the first kernel data.

Each of the plurality of first processing elements can shift the second non-zero element that is input in the second cycle into the adjacent second processing element. In addition, each of the plurality of second processing elements can shift the second non-zero element that is input in the second cycle to a processing element (not shown) adjacent to the lower side which is input in the second cycle.

In other words, the plurality of first processing elements and the plurality of second processing elements can be shifted in the previous cycle when the cycle is changed, and the element can be shifted to the lower processing element with the inputted second non-zero element. Because the same operation is repeated, description of the shift of the second non-zero element will be omitted.

Each of the plurality of first processing elements may perform an inter-element operation on the input first non-zero element and the input second non-zero element. Each of the plurality of first processing elements can add the operation result shifted from the second cycle to the operation result of the third cycle and store the summed operation result.

Each of the plurality of second processing elements may perform an inter-element operation between the input first non-zero element and the input second non-zero element that is input in the same operation method as the operation of the plurality of first processing element in the previous cycle and shift the operation result to a right side.

That is, each of the plurality of second processing elements can be operating in the same manner as the operation of the plurality of first processing elements in the previous cycle. Hereinafter, unless otherwise stated, the operations of the plurality of second processing elements are the same as those of the plurality of first processing elements in the previous cycle.

Each of FIGS. 5D, 5E, and 5F illustrates an operation according to the input of the second non-zero element of the second depth, third depth, and fourth depth included in the first row and the second column of the first kernel data. The operation is the same as the above and thus, detailed description is omitted.

Referring to FIG. 5G, the processor 120 may input the second non-zero element to a plurality of first processing elements in the seventh cycle. Here, the input second non-zero element is the second non-zero element of the fifth depth included in the first row and the second column of the first kernel data.

Each of the plurality of first processing elements may perform an inter-element operation on the input first non-zero element and the input second non-zero element. Each of the plurality of first processing elements can add the operation result of the seventh cycle to the operation result of the sixth cycle and shift it to the adjacent second processing element.

As described above, in the next cycle, the second non-zero element of the first depth included in the second row and the second column of the first kernel data will be input, which corresponds to a lower side of the first row and the second column of the first kernel data, and a shift direction may be downward. Each of the plurality of second processing elements may perform an inter-element operation between the input first non-zero element and the input second non-zero element.

Each of the plurality of second processing elements may store the operation result shifted from the adjacent first processing element separately from the operation result in the seventh cycle. That is, the operation result shifted from the processing element adjacent to the upper side in the downward direction is not added to the operation result of the current cycle.

Referring to FIG. 5H, the processor 120 may input the second non-zero element to the plurality of first processing elements in the eighth cycle. The input second non-zero element is the second non-zero element of the first depth included in the second row and the second column of the first kernel data.

Each of the plurality of first processing elements may perform an inter-element operation between the input first non-zero element and the input second non-zero element.

Each of the plurality of second processing elements may perform an inter-element operation on the input first non-zero element and the input second non-zero element. Each of the plurality of second processing elements may add the operation result in the seventh cycle and the operation result in the eighth cycle, and shift the summed operation result to the processing element adjacent to the lower side. However, the operation result shifted from the processing element adjacent to the upper side in the seventh cycle may be stored as it is in each of the plurality of second processing elements.

Referring to FIG. 5I, the processor 120 can input the second non-zero element to the plurality of first processing elements in the ninth cycle. The input second non-zero element is a second non-zero element of the second depth included in the second row and the second column of the first kernel data.

Each of the plurality of first processing elements performs an inter-element operation between the input first non-zero element and the input second non-zero element, and by adding the operation result of the previous cycle and the operation result of the present cycle, stores the added operation result.

Each of the plurality of second processing elements performs an inter-element operation between the input first non-zero element and the input second non-zero element, adds the operation result shifted from the processing element adjacent to the upper side in the seventh cycle and the operation result of the present cycle, and stores the added operation result.

FIGS. 5J and 5K illustrate operations according to the input of the second non-zero element of the third depth and the fifth depth included in the second row and the second column of the first kernel data. As described above, the operation method, the adding method, and the shifting method are the same, and as such, a detailed description is omitted.

However, as illustrated in FIG. 5K, the result of the added operation can be shifted to the left side. That is, the shift direction of the added result of FIG. 5K may be opposite to the shift direction of the added result of FIG. 5B.

Referring to FIG. 5L, the processor 120 may input zero to the plurality of first processing elements in the 12th cycle. Because there is no second non-zero element in the second row and the first column of the first kernel data, the processor 120 can input zero to the plurality of first processing elements.

In FIG. 5L, since the second non-zero element inputted in the next cycle is the second non-zero element of the second kernel data, the shift is unnecessary. However, if the second non-zero element to be input in the next cycle is a second non-zero element of the same first kernel data, the shift is performed. In this case, the processor 120 inputs zero to the plurality of first processing elements, and the operation result stored in each of the plurality of first processing elements can be shifted to the adjacent processing elements.

Referring to FIG. 5M, the processor 120 may input the second non-zero element to the plurality of first processing elements in the 13th cycle. The input second non-zero element is the second non-zero element of the second depth included in the first row and the first column of the second kernel data. The operations of the plurality of first processing elements and the plurality of second processing elements are the same as those described above.

By using the above-described method illustrated in FIGS. 5A to 5M, continued convolution operation can be performed on a plurality of kernel data. Here, the processor 120 may output the operation result for the first kernel data.

Although FIGS. 5A to 5M illustrate a plurality of processing elements in the form of a 4×4 matrix, the present disclosure is not limited thereto, and the number of processing elements may vary.

Also, although the target data has been described in the form of 4×4×5, it is not limited thereto, and it may be any other form. For example, when the target data is in the form of 16×16×5, and the plurality of processing elements in the form of 4×4 matrix are used, the processor 120 may divide the target data into four, based on the row and column of the target data, and the convolution operation may be performed.

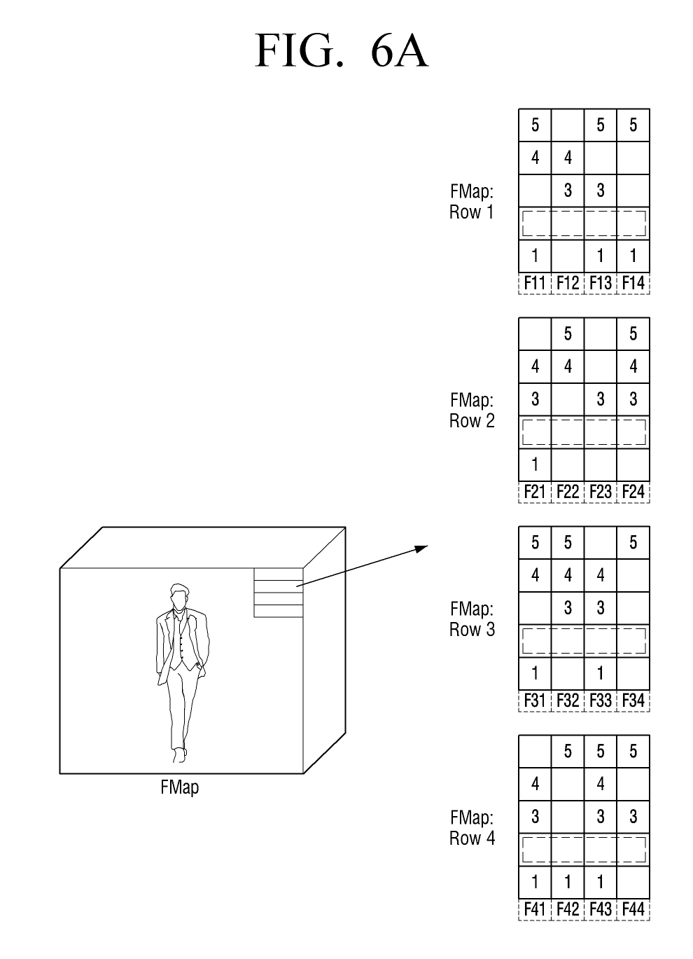

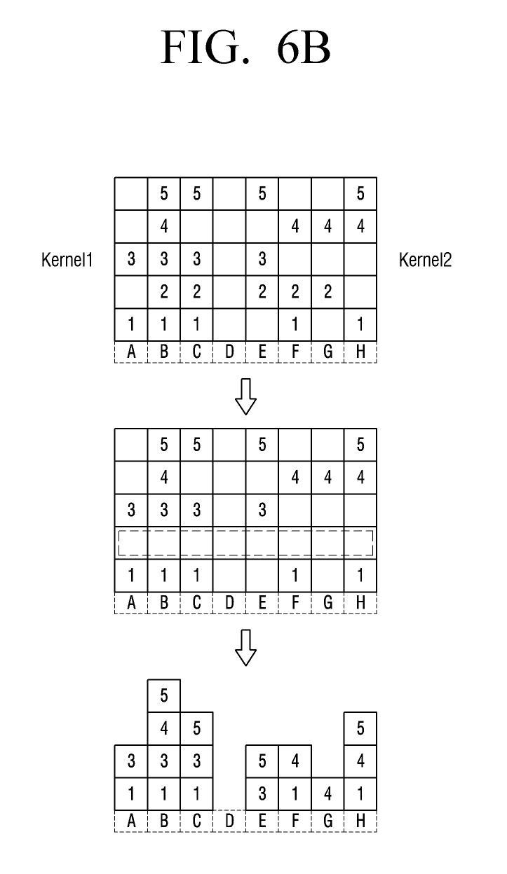

FIGS. 6A and 6B illustrate a method of processing data sparsity of kernel data according to an embodiment.

If the processor 120 identifies a depth having no first non-zero element in all rows and columns among the first non-zero elements stored in each of the plurality of processing elements, the processor may omit input of the second non-zero element corresponding to the depth from among the second element and sequentially input the second non-zero element not corresponding to the depth to each of the plurality of first processing elements.

For example, as illustrated in FIG. 6A, the processor 120 may identify that there is no first non-zero element corresponding to the second depth from among the first non-zero elements stored in each of the plurality of processing elements. In this case, the processor 120 may remove the second non-zero element of the second depth included in the first kernel data and the second kernel data, and sequentially input the remaining second non-zero element to a plurality of the first processing elements.

The processor 120 may remove the second non-zero element of the second depth included in the first kernel data and the second kernel data, separately store the remaining second non-zero element in the storage 110, and sequentially extract the remaining second non-zero element to input to the plurality of first processing elements. Alternatively, the processor 120 may sequentially extract the second non-zero element from the first kernel data and the second kernel data, and when the second non-zero element of the second depth is identified, this will be skipped, and the second non-zero element, which is not the second depth, may be extracted and input to the plurality of first processing elements.

Alternatively, as illustrated in FIG. 6B, the processor 120 may identify a depth with no first non-zero element in all rows and all columns before the first non-zero element is input into each of the plurality of processing elements.

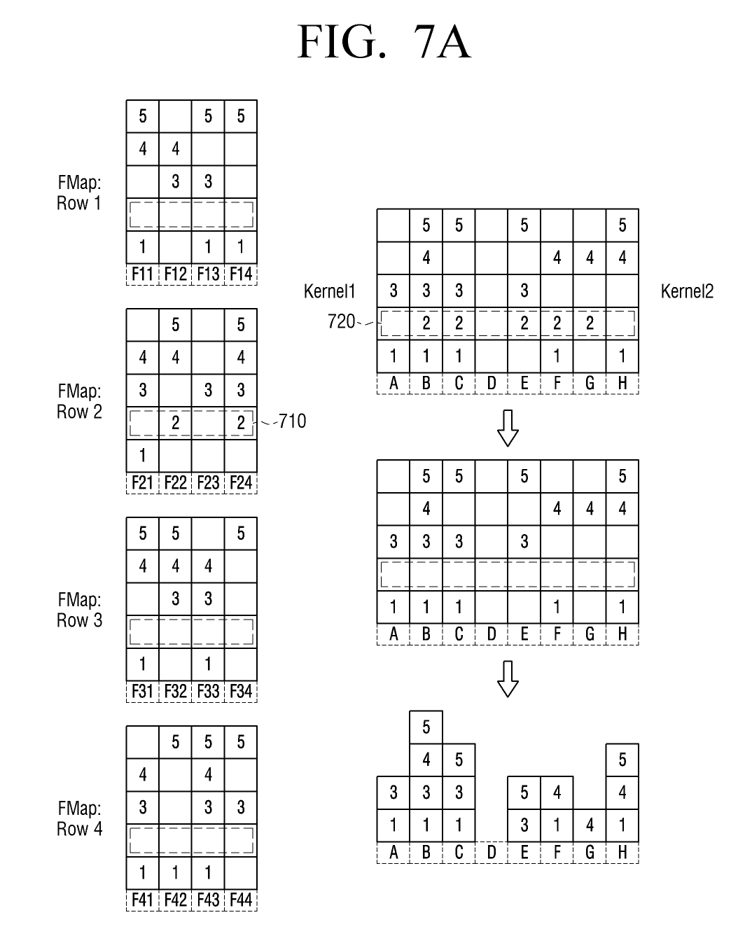

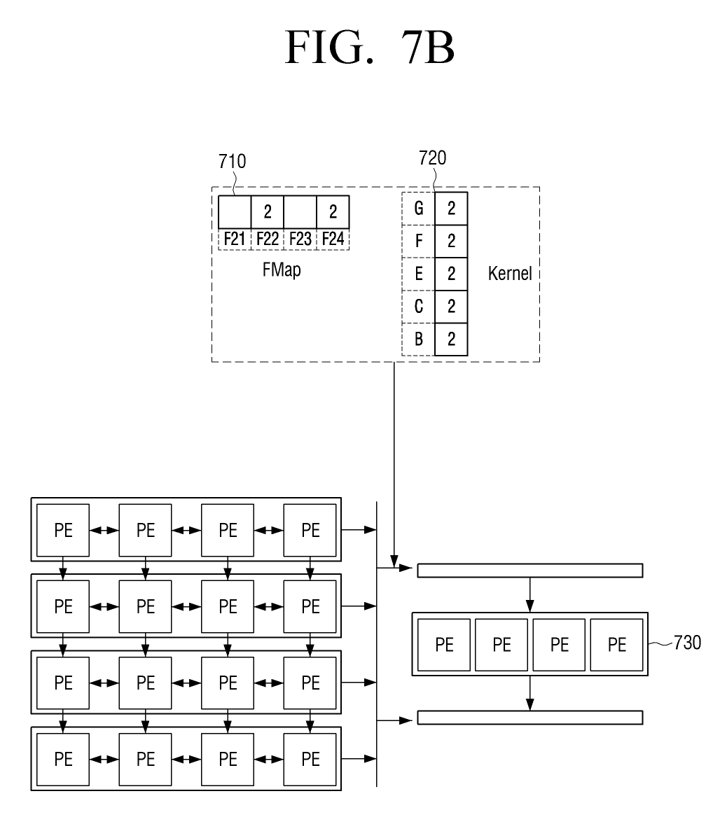

FIGS. 7A and 7B illustrate a method for processing data sparsity of target data according to an embodiment.

The processor 120, if the depth in which the first non-zero element is within a predetermined number in all the rows and columns is identified from among the first non-zero element stored in each of the plurality of processing elements, may omit input of the second non-zero element corresponding to the identified depth from among the second element and sequentially input the second non-zero element not corresponding to the depth to each of the plurality of the first processing elements.

For example, as illustrated in FIG. 7A, the processor 120 may, when the second depth which has the first non-zero element which is less than three in all of the rows and columns, from among the first non-zero elements stored in each of the plurality of processing elements, is identified, input of the second non-zero element 720 corresponding to the second depth from among the second elements is omitted, and the second non-zero element that does not correspond to the second depth may be sequentially input to each of the plurality of the first processing elements.

In this case, the first non-zero element of the identified depth may be stored in a part of the plurality of processing elements, but unless the second non-zero element 720 of the identified depth is input, an operation is not performed, and thus, cycle can be shortened. The shortened cycle is the same as illustrated in FIGS. 6A and 6B.

The processor 120 may further include a plurality of preliminary processing elements, and the first non-zero element that corresponds to the identified depth and the second non-zero element that corresponds to the identified depth may be input to a plurality of preliminary processing elements to perform a separate operation.

For example, as illustrated in FIG. 7B, the processor 120 may further include a plurality of pre-processing elements 730, and may input the first non-zero element 710 corresponding to the identified depth and the second non-zero element 720 corresponding to the identified depth to the plurality of the pre-processing elements 730 to perform a separate operation.

In other words, the processor 120 may perform operations illustrated in FIGS. 5A to 5M using a plurality of processing elements, and operate the first non-zero element 710 corresponding to the identified depth and the second non-zero element 720 corresponding to the identified depth using a plurality of the pre-processing elements 730 in parallel.

Thereafter, the processor 120 may add the operation results output from the plurality of pre-processing elements 730 to the corresponding operation results from among the operation results output from the plurality of processing elements.

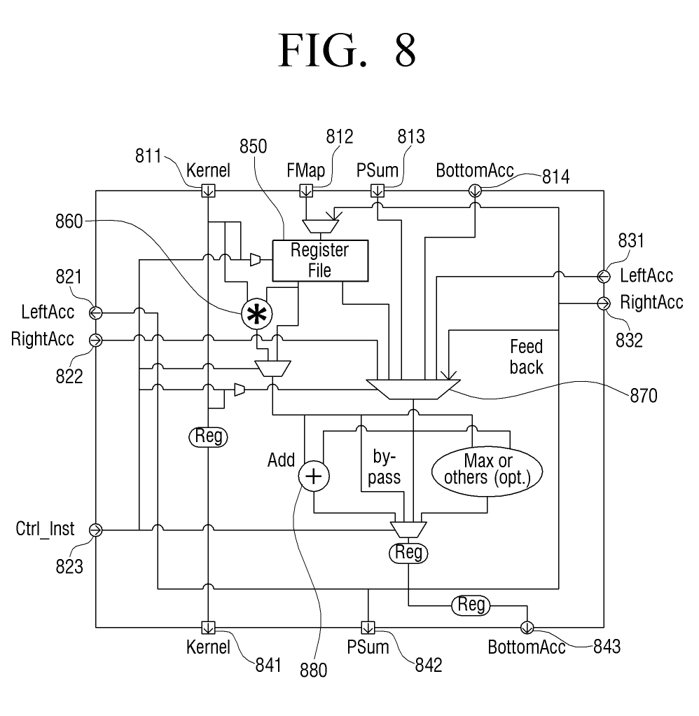

FIG. 8 illustrates a processing element according to an embodiment.

Referring to FIG. 8, a processing element includes a Kernel terminal 811, an FMap terminal 812, a PSum terminal 813, a BottomAcc terminal 814, a LeftAcc terminal 821, a RightAcc terminal 822, a Ctrl_Inst terminal 823, a LeftAcc terminal 831, a RightAcc terminal 832, a Kernel terminal 841, a PSum terminal 842, a BottomAcc terminal 843, a register file 850, a multiplier 860, a multiplexer 870, and an adder 880.

The processing element may receive the second non-zero element, the first non-zero element, and data and an instruction stored in the storage 110 through each of the kernel terminal 811, the Fmap terminal 812, the Psum terminal 813, and the Ctrl_Inst terminal 823. In addition, the processing element can shift the second non-zero element to the processing element adjacent to the lower part via the Kernel terminal 841. In particular, the processing element can receive or output data directly to the storage 110 using the PSum terminal 813 and the PSum terminal 842.

The processing element can receive the operation result from the adjacent processing element through the BottomAcc terminal 814, the RightAcc terminal 822, and the LeftAcc terminal 831. Further, the processing element can shift the operation result directly processed to the adjacent processing element through the LeftAcc terminal 821, the RightAcc terminal 832, and the BottomAcc terminal 843.

The register file 850 may store the first non-zero element and the operation result input through the FMap terminal 812.

The multiplier 860 may perform a multiplication operation of the second non-zero element input through the Kernel terminal 811 and the first non-zero element input from the Register File 850.

The multiplexer 870 may provide one of the operation result that is input from an adjacent processing element, the operation result processed in a processing element, data input from the PSum terminal 813, and data input from the register file 850 to the adder 8810.

The Adder 880 can perform addition operations of the multiplication result input from the multiplier 860 and the data input from the multiplexer 870.

A processing element may further include a multiplexer.

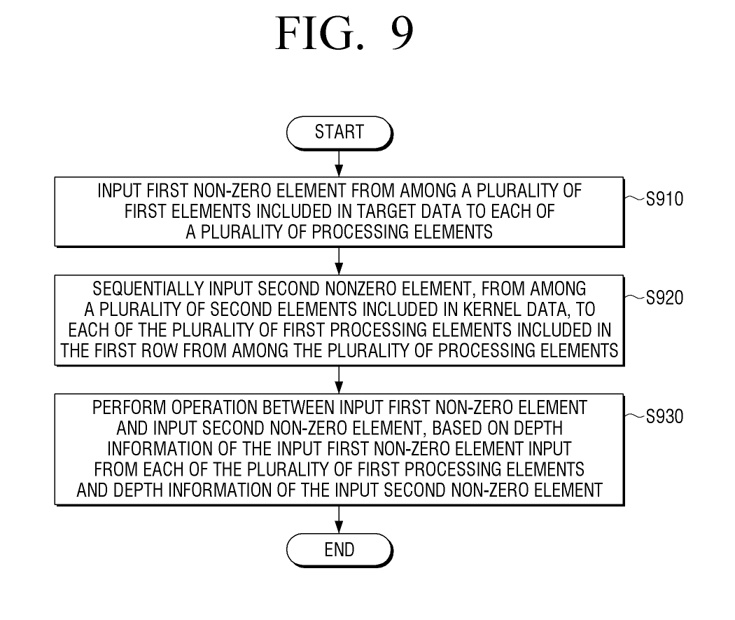

FIG. 9 is a flowchart illustrating a method of controlling an electronic apparatus according to an embodiment. For example, the electronic apparatus may include a processor that performs deep learning, a storage that stores target data and kernel data, and a plurality of processing elements arranged in a matrix form.

Referring to FIG. 9, the first non-zero element among a plurality of the first elements included in the target data is input to each of the plurality of processing elements in step S910.

In step S920, the second non-zero element from among the plurality of second elements included in the kernel data is sequentially input to each of the plurality of first processing elements included in the first row of the plurality of processing elements.

Based on the input depth information of the first non-zero element and the input depth information of the second non-zero element input from each of the plurality of first processing elements, the operation between the input first non-zero element and the input second non-zero element is performed in step S930.

Each of the plurality of processing elements includes a plurality of register files, and inputting the first non-zero element in step S910 may include identifying a corresponding processing element from among a plurality of processing elements based on the row information and the column information of the first non-zero element and inputting the first non-zero element to a corresponding register file from among a plurality of register files included in the identified processing element.

The step S920 of sequentially inputting the second non-zero element may include sequentially inputting the second non-zero elements to the plurality of first processing elements, based on the row information, the column information, and the depth information of the second non-zero element.

The step S920 of sequentially inputting the second non-zero element may include sequentially inputting the second non-zero element included in one row and one column from among the second non-zero elements to each of the plurality of the first processing elements based on the depth and, if all the second non-zero element included in one row and one column is input to each of the plurality of processing elements, inputting the second non-zero element included in a row and a column different from the one row and the one column to each of the plurality of the first processing elements.

In addition, the step S920 of sequentially inputting the second non-zero element includes, when there is no second non-zero element in one row and one column, inputting zero to each of the plurality of the first processing elements, and if zero is input to each of the plurality of processing elements, inputting the second non-zero element included in another row and column or zero to each of the plurality of the first processing elements based on the number of the second non-zero element included in another row and column.

The step S920 of sequentially inputting the second non-zero element may include, when a depth which has no first non-zero element in all the rows and columns is identified from among the first non-zero elements stored in each of the plurality of processing elements, omitting input of the second non-zero element corresponding to the depth from among the second elements and sequentially inputting the second non-zero element not corresponding to the depth to each of the first plurality of first processing elements.

In addition, the step S920 of sequentially inputting the second non-zero element includes, when the depth in which the first non-zero element is within a predetermined number in all the rows and columns is identified from among the first non-zero element stored in each of the plurality of processing elements, omitting input of the second non-zero element corresponding to the depth from among the second elements, sequentially inputting the second non-zero element not corresponding to the depth to each of the plurality of the first processing elements, and inputting the first non-zero element corresponding to the depth and the second non-zero element corresponding to the depth to a plurality of preliminary processing elements included in the process.

When the operation between the elements is completed in the plurality of first processing elements, the input second non-zero element may be shifted to each of the plurality of second processing elements included in the second row. If an operation between the non-zero elements is completed in the plurality of the second processing elements, the shifted second non-zero element may be shifted from the plurality of second processing elements to each of the plurality of third processing elements included in the third row.

When the second no-zero element input to each of the plurality of processing elements belongs to the same row and the same column as the second non-zero, the input second non-zero element may be accumulated with the previous operation result, and the result thereof may be stored to one of the plurality of register files.

If the second non-zero element that is input to each of the plurality of processing elements does not belong to the same row and the same column as the second non-zero element used for the operation immediately before, the operation result stored in one of the plurality of register files of each of the plurality of processing elements may be shifted to an adjacent processing element, and the input second non-zero element may be accumulated with the shifted operation result and then stored in one of the plurality of register files.

According to the various embodiments of the present disclosure as described above, an electronic apparatus can improve the speed of a convolution operation by omitting calculations of a part of target data and a part of kernel data according to a zero included in the target data.

The target data and the kernel data described above may be in any form of three-dimensional data. Also, the number of the plurality of processing elements included in the processor may be different as well.

In accordance with an embodiment of the present disclosure, the various embodiments described above may be implemented with software that includes instructions stored on a machine-readable storage medium which can be read by a machine (e.g., a computer). The device calls an instruction stored from a storage medium and is operable according to a called instruction, and may include an electronic apparatus (e.g.: an electronic apparatus). When an instruction is executed by a processor, the processor may perform functions corresponding to the instruction, either directly or under the control of the processor, using other components. The instruction may include code generated or executed by a compiler or an interpreter.

A machine-readable storage medium may be provided in the form of a non-transitory storage medium.

In accordance with an embodiment of the present disclosure, a method according to various embodiments described above may be provided in a computer program product. A computer program product may be traded between a seller and a purchaser as a commodity. The computer program product may be distributed in the form of a machine-readable storage medium (e.g., a compact disc read only memory (CD-ROM)) or distributed online through an application store (e.g., PlayStore™). For on-line distribution, at least a portion of the computer program product may be stored temporarily or at least provisionally in a storage medium, such as a manufacturer's server, a server of an application store, or a memory of a relay server.

Further, the various embodiments described above may be implemented within a computer readable medium, such as a computer or a similar device, using software, hardware, or combination thereof. In some cases, the embodiments described herein may be implemented by the processor itself. According to a software implementation, embodiments such as the procedures and functions described herein may be implemented in separate software modules. Each of the software modules may perform one or more of the functions and operations described herein.

Computer instructions for performing the processing operations of the apparatus according to various embodiments described above may be stored in a non-transitory computer-readable medium. The computer instructions stored in the non-volatile computer-readable medium cause a particular device to perform a processing operation on the device according to various embodiments described above when executed by a processor of the particular device. Non-transitory computer readable media is a medium that stores data for a short period of time, such as a register, cache, memory, etc., but semi-permanently stores data and is readable by the device. Specific examples of non-transitory computer readable media include CD, DVD, hard disk, Blu-ray disk, USB, memory card, ROM, etc.

Further, each of the components (e.g., modules or programs) according to the above-described various embodiments may include one or a plurality of entities, and some subcomponents of the subcomponents described above may be omitted. The components may be further included in various embodiments. Alternatively or additionally, some components (e.g., modules or programs) may be integrated into one entity to perform the same or similar functions performed by each respective component prior to integration. Operations performed by a module, program, or other component, in accordance with various embodiments, may be performed in a sequential, parallel, iterative, or heuristic manner, or at least some operations may be performed in a different order.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. An electronic apparatus for performing deep learning, the electronic apparatus comprising:
a storage configured to store target data and kernel data; and
a processor including a plurality of processing elements that are arranged in a matrix shape, wherein the processor is configured to:
input, to each of the plurality of processing elements, a first non-zero element from among a plurality of first elements included in the target data, and
sequentially input, to each of a plurality of first processing elements included in a first row from among the plurality of processing elements, a second non-zero element from among the plurality of elements included in the kernel data,
wherein each of the plurality of first processing elements is configured to perform an operation between the input first non-zero element and the input second non-zero element, based on depth information of the first non-zero element and depth information of the second non-zero element.

2. The electronic apparatus of claim 1, wherein each of the plurality of processing elements comprises a plurality of register files, and
wherein the processor is further configured to:
identify a corresponding processing element from among the plurality of processing elements based on row information and column information of the first non-zero element, and
input the first non-zero element to a corresponding register file from among the plurality of register files included in the identified processing elements, based on the depth information of the first non-zero element.

3. The electronic apparatus of claim 2, wherein the processor is further configured to sequentially input the second non-zero element to each of the plurality of first processing elements based on row information, column information, and the depth information of the second non-zero element.

4. The electronic apparatus of claim 3, wherein the processor is further configured to:
sequentially input a second non-zero element included in one row and one column, from among the second non-zero element, to each of the plurality of first processing elements based on depth, and
when all of the second non-zero elements included in the one row and the one column are input to each of the plurality of first processing elements, input the second non-zero element included in a row and a column that is different from the one row and the one column to each of the plurality of first processing elements.

5. The electronic apparatus of claim 4, wherein the processor is further configured to:
when there is no second non-zero element in the one row and the one column, input zero to each of the plurality of first processing elements, and
when the zero is input to each of the plurality of first processing elements, input the second non-zero element included in a different row and column, based on a number of the second non-zero elements included in the different row and column, to each of the plurality of first processing elements.

6. The electronic apparatus of claim 3, wherein the processor is further configured to, when a depth that has no first non-zero element in all the rows and columns from among the first non-zero elements stored in each of the plurality of processing elements is identified, omit input of the second non-zero element corresponding to the depth from among the second element, and sequentially input the second non-zero element not corresponding to the depth to each of the plurality of first processing elements.

7. The electronic apparatus of claim 3, wherein the processor further includes a plurality of preliminary processing elements, and
wherein the processor is further configured to:
when a depth of which the non-zero element is within a predetermined number in all the rows and columns corresponding to the depth, is identified, from among the first non-zero elements stored in each of the plurality of processing elements, omit input of the second non-zero element corresponding to the depth and sequentially input the second non-zero elements not corresponding to the depth to each of the plurality of first processing elements, and
input the first non-zero element corresponding to the depth and the second non-zero element corresponding to the depth to a plurality of preliminary processing elements to perform operation.

8. The electronic apparatus of claim 3, wherein the processor is further configured to:
when the operation between non-zero elements in the plurality of first processing elements is completed, control the plurality of processing elements to shift the second non-zero elements that are input to the plurality of first processing elements to each of a plurality of second processing elements included in a second row, and
when the operation between non-zero elements is completed in the plurality of second processing elements, control the plurality of processing elements to shift the second non-zero elements that are shifted to the plurality of second processing elements to each of a plurality of third processing elements included in a third row from among the plurality of processing elements.

9. The electronic apparatus of claim 8, wherein the processor is further configured to, when the second non-zero element that is input to each of the plurality of processing elements belongs to a same row and a same column as a second non-zero element that is used immediately before, accumulate an operation result of the input second non-zero element with a previous operation result and store the accumulated operation results in one of the plurality of register files.

10. The electronic apparatus of claim 8, wherein the processor is further configured to, when the second non-zero element that is input to each of the plurality of processing elements does not belong to a same row and a same column as a second non-zero element used for an operation immediately before, shift an operation result stored in one of the plurality of register files of each of the plurality of processing elements to an adjacent processing element, and accumulate an operation result by the input second non-zero element to the shifted operation result and store the accumulated operation results in one of the plurality of register files.

11. A method of controlling an electronic apparatus to perform deep learning, wherein the electronic apparatus comprises a processor including a plurality of processing elements that are arranged in a matrix shape, the method comprising:
inputting, to each of the plurality of processing elements, a first non-zero element from among a plurality of first elements included in target data;
sequentially inputting, to each of a plurality of first processing elements included in a first row from among the plurality of processing elements, a second non-zero element from among the plurality of elements included in kernel data; and
performing an operation between the input first non-zero element and the input second non-zero element, based on depth information of the first non-zero element and depth information of the second non-zero element.

12. The method of claim 11, wherein each of the plurality of processing elements comprises a plurality of register files, and
wherein inputting the first non-zero element comprises:
identifying a corresponding processing element from among the plurality of processing elements based on row information and column information of the first non-zero element; and
inputting the first non-zero element to a corresponding register file from among the plurality of register files included in the identified processing elements based on the depth information of the first non-zero element.

13. The method of claim 12, wherein sequentially inputting the second non-zero element comprises sequentially inputting the second non-zero element to each of the plurality of first processing elements based on row information, column information, and the depth information of the second non-zero element.

14. The method of claim 13, wherein sequentially inputting the second non-zero element comprises:
sequentially inputting a second non-zero element included in one row and one column, from among the second non-zero element, to each of the plurality of first processing elements based on depth; and
when all of the second non-zero elements included in the one row and the one column are input to each of the plurality of first processing elements, inputting the second non-zero element included in a row and a column that is different from the one row and the one column to each of the plurality of first processing elements.

15. The method of claim 14, wherein sequentially inputting the second non-zero element comprises:
when there is no second non-zero element in the one row and the one column, inputting zero to each of the plurality of first processing elements; and
when the zero is input to each of the plurality of first processing elements, inputting the second non-zero element included in a different row and column, based on a number of the second non-zero elements included in the different row and column, to each of the plurality of first processing elements.

16. The method of claim 13, wherein sequentially inputting the second non-zero element comprises:
when a depth that has no first non-zero element in all the rows and columns from among the first non-zero elements stored in each of the plurality of processing elements is identified, omitting input of the second non-zero element corresponding to the depth from among the second element; and
sequentially inputting the second non-zero element not corresponding to the depth to each of the plurality of first processing elements.

17. The method of claim 13, wherein sequentially inputting the second non-zero element comprises:
when a depth of which the non-zero element is within a predetermined number in all the rows and columns corresponding to the depth, is identified, from among the first non-zero elements stored in each of the plurality of processing elements, omitting input of the second non-zero element corresponding to the depth, and sequentially inputting the second non-zero elements not corresponding to the depth to each of the plurality of first processing elements, and
wherein the method further comprises inputting the first non-zero element corresponding to the depth and the second non-zero element corresponding to the depth to a plurality of preliminary processing elements to perform an operation.

18. The method of claim 13, further comprising:
when the operation between non-zero elements in the plurality of first processing elements is completed, shifting the second non-zero elements that are input to the plurality of first processing elements to each of a plurality of second processing elements included in a second row; and
when the operation between non-zero elements is completed in the plurality of second processing elements, shifting the second non-zero elements that are shifted to the plurality of second processing elements to each of a plurality of third processing elements included in a third row from among the plurality of processing elements.

19. The method of claim 18, further comprising:
when the second non-zero element that is input to each of the plurality of processing elements belongs to a same row and a same column as a second non-zero element that is used immediately before, accumulating an operation result of the input second non-zero element with a previous operation result and storing the accumulated operation results in one of the plurality of register files.

20. The method of claim 18, further comprising:
when the second non-zero element that is input to each of the plurality of processing elements does not belong to a same row and a same column as a second non-zero element used for an operation immediately before, shifting an operation result stored in one of the plurality of register files of each of the plurality of processing elements to an adjacent processing element;
accumulating an operation result by the input second non-zero element to the shifted operation result; and
storing the accumulated operation results in one of the plurality of register files.
